(19) United States
(12) Patent Application Publication
(10) Pub. No.: US 2007/0292955 A1
(43) Pub. Date: Dec. 20, 2007

(54) Analytical Device And Method For Analysing A Sample, As Well As Injection Assembly For Use With Such An Analytical Device

(76) Inventors: Marinus Arnolds Wilhelmus Van Der Zalm, Den Hoorn (NL); Quirinus Adrianus Sprinkhuizen, Den Haag (NL); Johan Hendrik Wagemaker, Delft (NL)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/573,848

(22) PCT Filed: Aug. 19, 2005
(86) PCT No.: PCT/NL05/00603

§ 371 Date: Aug. 6, 2007

(30) Foreign Application Priority Data
Aug. 19, 2004 (NL) 1026878

(51) Int. Cl. G01N 31/12; B01J 19/00

(52) U.S. Cl. 436/2; 422/78

(57) ABSTRACT

Analytical device for analysing a sample, such as a water sample, comprises a combustion chamber for at least partially combusting the sample to give combustion products, wherein the combustion chamber has an inlet side and an outlet side. A measurement chamber is connected to the outlet side of the combustion chamber, wherein the measurement chamber has measurement means for measuring a component of the combustion products. The analytical device furthermore comprises an introduction module, that is arranged in fluid communication with the inlet side of the combustion chamber. An injection port is arranged in fluid communication with the introduction module. The injection port has a first feed opening for receiving the sample and a discharge opening that is in fluid communication with the first feed opening and is connected to the introduction module. A second feed opening for feeding a gas is provided upstream of the introduction module.

The invention relates to an analytical device for analysing a sample, such as a water sample, comprising:
a combustion chamber for at least partially combusting the sample to give combustion products, wherein the combustion chamber has an inlet side and an outlet side;
a measurement chamber that is connected to the outlet side of the combustion chamber, wherein the measurement chamber has measuring means for measuring a component of the combustion products; as well as
an introduction module that is arranged in fluid communication with the inlet side of the combustion chamber; as well as
an injection port that is arranged in fluid communication with the introduction module, which injection port has a first feed opening for receiving the sample and has a discharge opening that is in fluid communication with the first feed opening and is connected to the introduction module.

Such a device is disclosed in NL 1 007 860. This device is used to determine the nitrogen content in samples of a product. The analysis of a product can also relate to components other than nitrogen (N), such as carbon (C), chloride (Cl) or sulphur (S).

The analysis of samples plays an important role in environmental applications, such as compliance with environmental regulations. The sample comprises, for example, a liquid, such as a water sample. Usually the water sample is groundwater, surface water, waste water or drinking water. In addition, analysis of other products, for example hydrocarbons, such as benzine or kerosene, and other biological and chemical products takes place.

Several samples to be analysed are stored in a storage device, a so-called auto sampler. An injection needle draws up a desired sample from the auto sampler, after which said injection needle is inserted into an injection port. The sample then flows into the injection port, which is connected via tubing to an introduction needle. The introduction needle can be accommodated in the introduction module of the analytical device. The sample is fed from the injection port via the tubing and the introduction needle to the introduction module. The introduction module is usually made of quartz.

The introduction module has a feed opening for an inert gas, such as argon, and a feed opening for oxygen. The inert gas and/or the oxygen form a base flow that flows continuously through the device. The base flow provides reference conditions in the measurement chamber during each determination of the component of the combustion products of a sample. These reference conditions correspond to a zero line. The quantity of the component to be analysed in a sample is determined with respect to said zero line.

The mixture of the sample and said gases flows from the introduction module to the combustion chamber in which a temperature of approximately 1000° C. prevails. The combustion chamber usually contains a catalyst, for example ceramic balls that are encased in platinum. It is advantageous if the combustion reactions take place at the catalyst.

The temperature difference between the introduction module, where a temperature of approximately 50° C. prevails at the feed end, and the combustion chamber is, however, particularly large. As a result a chemical reaction of the sample will already take place in the introduction module. This premature reaction of the sample reduces the reproducibility of the determination and can give rise to inaccuracy thereof.

The object of the invention is to provide an analytical device for analysing a sample with which accuracy is improved.

According to the invention said object is achieved in that a second feed opening for feeding a gas is provided upstream of the introduction module. Preferably, the second feed opening is made in the injection port.

The gas fed to the injection port is, for example, at room temperature or a lower temperature. As a result the gas will cool the sample in the introduction needle, so that the temperature of the sample remains below the reaction temperature for a longer period. The occurrence of a reaction is postponed, so that the risk of the sample already partially reacting in the introduction module is reduced. Combustion proceeds in a controlled manner in the combustion chamber, essentially completely at the location of the catalyst. This is advantageous in connection with the reproducibility of the determination.

The second feed opening can open into the sample stream. As a result the gas supplied will counteract blockage. Water samples or other liquid samples can contain impurities, such as mud particles. Such solid particles can clog the discharge opening of the injection port or the introduction needle. The gas supplied blows through the injection port and the injection needle, so that said solid particles flow through better. The gas supplied removes any clogged particles.

In a preferred embodiment of the invention the gas fed to the injection port comprises oxygen. This is important in particular for the measurement of water samples.

Various types of nitrogen compounds, including nitrate/nitrite (NO₃⁻/NO₂⁻) compounds, ammonium (NH₄⁺) compounds and organic compounds, in particular (C—N) compounds occur in water samples. The nitrate/nitrite (NO₃⁻/NO₂⁻) compounds react during the combustion by reduction to give nitrogen monoxide (NO), whilst the ammonium (NH₄⁺) compounds and organic compounds are converted during the combustion by oxidation into nitrogen monoxide (NO). Reduction and oxidation are different chemical reactions.

Little oxygen (O₂) is required for reduction; an oxygen-rich environment can even have an adverse effect on the reduction. The nitrate/nitrite determination can become inaccurate as a result of feeding a large amount of oxygen to the introduction module. Nitrate/nitrite reacts slowly with oxygen, as a result of which the quantity of oxygen does not remain in the combustion chamber long enough to react completely. The detection of nitrogen monoxide (NO) in the measurement chamber is spread over time and gives a relatively low peak with respect to the zero line.

On the other hand, an appreciable quantity of oxygen (O₂) has a beneficial effect for oxidation. Ammonia reacts rapidly with oxygen. The ammonia determination will become inaccurate as a result of feeding a small quantity of oxygen. The quantity of oxygen fed into the introduction module must therefore be a compromise.

International regulations impose requirements on the accuracy of analytical devices for water samples. In a standard measurement, for example determination of a water sample containing a nitrate/nitrite with a concentration of 25 mg nitrogen per litre water and a water sample containing ammonium with a concentration of 25 mg nitrogen per litre water, the determined amount of nitrogen monoxide (NO) for nitrate/nitrite must not deviate by more than 10% from the determined amount of nitrogen monoxide (NO) for ammonium.

According to the preferred embodiment of the invention oxygen fed to the injection port is carried along by the water sample. The oxygen is therefore present in the sample at an earlier stage. As a result it is possible to achieve accurate determinations with less oxygen because the nitrate/nitrite compounds have more time to react. In practice the accuracy of the analytical device is found to be appreciably improved.

It is preferable that the first feed opening of the injection port has a conical guide surface. The guide surface guides the injection needle during insertion into the injection port to prevent damage thereto.

The introduction module can have an elongated peripheral wall which has a central channel for accommodating the introduction needle, which channel opens into the combustion chamber. With this arrangement it is possible that the central channel has a first gas inlet opening for an inert gas, for example argon, to form the base flow. According to the invention the peripheral wall of the introduction module has a second gas inlet opening for oxygen which adjoins a cooling channel that is arranged adjacent to the central channel. The oxygen that is needed for the combustion is therefore guided closely along the introduction needle. As a result of thermal conduction through the dividing wall between the central channel and the cooling channel and then convection, the oxygen removes heat to cool the introduction needle.

In a particular embodiment according to the invention the cooling channel has two channel sections which are connected in series, wherein the first channel section extends from the gas inlet opening to a return point close to the combustion chamber, and the second channel section extends from said return point back towards the gas inlet opening. In this case the oxygen, which acts as cooling agent, follows two flow paths along the introduction needle. Although the oxygen in the second flow path has already been heated to some extent, heat will still be removed from the introduction needle.

The inside of the introduction module can be covered with a nickel foil. Especially in water samples, there are salts that can attack the quartz glass of the introduction module. The nickel foil forms a protective layer against this.

It is possible that the injection port is made of Teflon. Teflon is unlikely to react with the sample or the oxygen, so that the material of the injection port will not influence the determination.

The invention also relates to an injection assembly for use with an analytical device as described above.

In addition the invention relates to a method for analysing a sample, such as a water sample, comprising feeding the sample to an injection port, transporting the sample from the injection port to an introduction module, which can be connected to a combustion chamber, transferring the sample from the introduction module to the combustion chamber, at least partially combusting the sample to give combustion products in the combustion chamber, transporting the combustion products from the combustion chamber to a measurement chamber, measuring a component of the combustion products in the measurement chamber. According to the invention a gas is fed to the sample upstream of the introduction module.

An illustrative embodiment of the invention will now be explained in more detail with reference to the appended drawing. In the drawing:

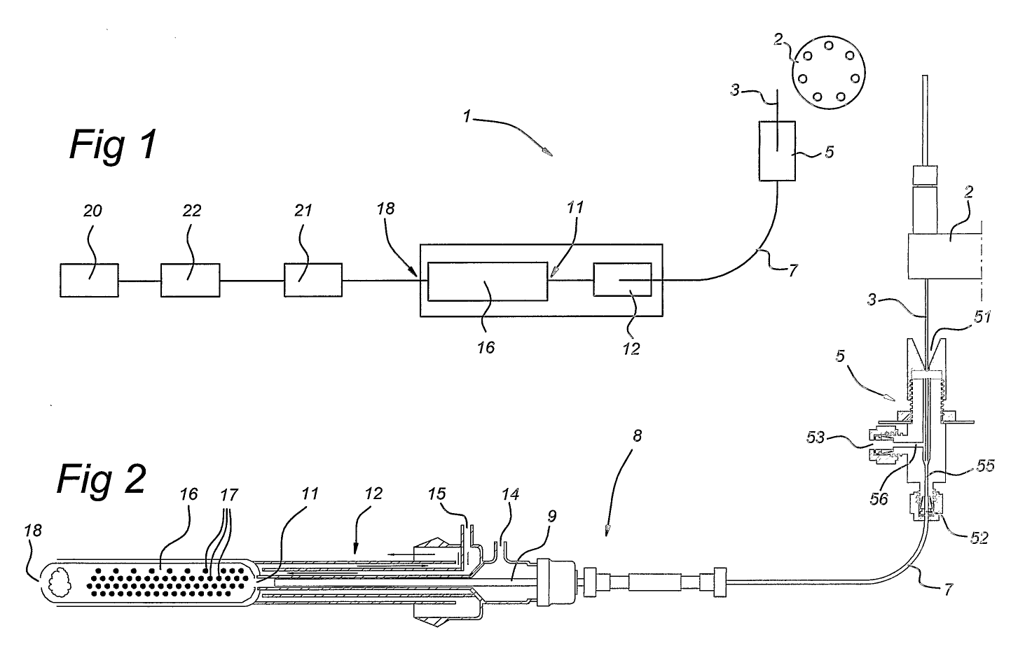

FIG. 1 shows a diagrammatic side view of an analytical device according to the invention;

FIG. 2 shows a side view of the injection assembly and a combustion chamber of the analytical device shown in FIG. 1;

FIG. 3 shows a first detail from FIG. 2;

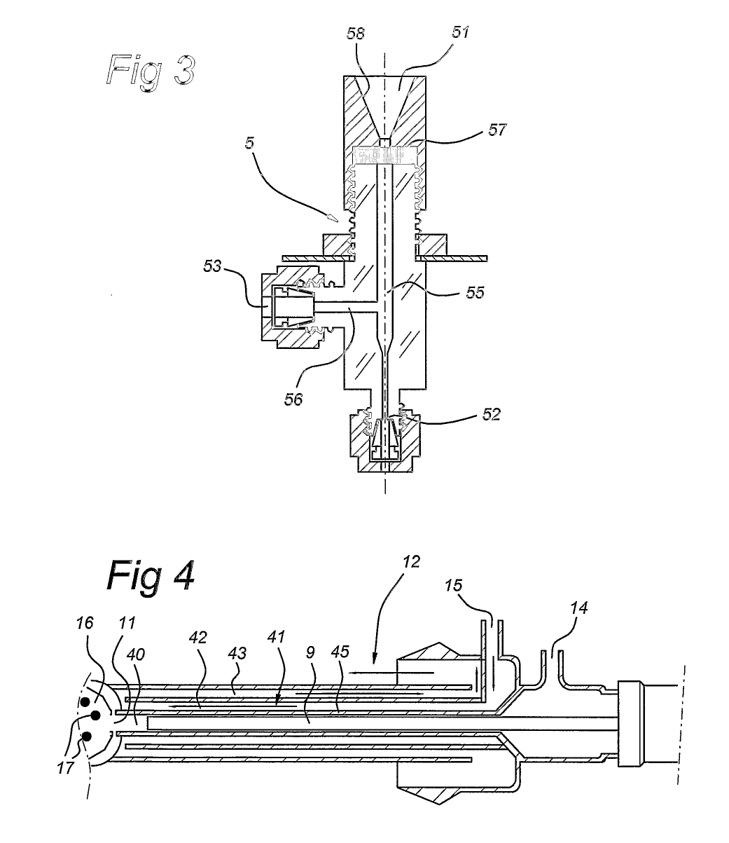

FIG. 4 shows a second detail from FIG. 2.

With reference to FIGS. 1 and 2 the analytical device or instrument according to the invention is indicated in its entirety by 1. Several water samples to be analysed are stored in a storage device 2, a so-called auto sampler. An injection needle 3 draws up a desired sample from the auto sampler 2, after which said injection needle 3 is inserted into an injection port 5. The sample then flows into the injection port 5, which is connected via tubing 7 to an introduction needle 9. The introduction needle 9 is inserted in an introduction module 12, which usually is made of quartz glass. The injection port 5 and the introduction module 12 form part of an injection assembly 8.

As is most clearly shown in FIG. 4, the introduction module 12 has a feed opening 14 for an inert gas, such as argon, and a feed opening 15 for oxygen. The inert gas and/or the oxygen form a base flow, which flows continuously through the device 1. The base flow provides reference conditions during each measurement. These reference conditions correspond to a zero line. The amount of the component to be analysed in a sample is determined with reference to said zero line.

The introduction module 12 is connected to the inlet side 11 of a combustion chamber 16. In this illustrative embodiment the introduction module 12 and the combustion chamber 16 are integrated in one component. The mixture of the sample and added gases flows from the introduction module 12 to the combustion chamber 16, the so-called hot zone, in which a temperature of approximately 1000° C. prevails. The combustion chamber 16 contains a catalyst in the form of ceramic balls 17 that are encased in platinum (see FIG. 2). It is advantageous if the combustion reactions take place with the catalyst, that is to say in the combustion chamber and not upstream or downstream of this.

The water sample reacts as a result of the combustion with the aid of the catalyst. The nitrogen compounds in the sample are converted into the combustion products nitrogen monoxide (NO) and nitrogen dioxide (NO₂). These combustion products are detected in a measurement chamber 20, which is connected to the outlet side 18 of the combustion chamber 16.

The amount of NOₓ that has formed after combustion is a measure for the amount of N that was present in the sample in bound form before combustion. By determining the molecules of the compounds NOₓ after combustion the nitrogen (N) content in the sample can be found.

Before the measurement in the measurement chamber 20 for nitrogen, a so-called NO converter 21 first converts all nitrogen dioxide (NO₂) into nitrogen monoxide (NO). Ozone (O₃) is then added just before the measurement chamber, which is indicated diagrammatically in FIG. 1 by 22. The nitrogen monoxide (NO) reacts with the ozone (O₃), nitrogen dioxide in an activated state (NO₂*) being formed. This activated state is unstable and the NO₂* will immediately decay to the base state. Light is emitted during the decay. In the reaction equation:
NO+O₃→NO₂*
NO₂*→NO₂+hυ
The measurement chamber 20 has a light sensor, such as a chemical luminescence detector, which measures the amount of light. The amount of light emitted during the decay is a measure for the amount of NO and this corresponds to the amount of nitrogen (N) that was present in bound form in the sample.

The component determined in a sample is a deflection compared with the zero line. This deflection usually has a parabolic shape over time. The surface area between the deflection and the zero line corresponds to the amount of nitrogen (N) in the sample.

Incidentally, the measurement chamber can be equipped to measure a component other than nitrogen, for example carbon (C), sulphur (S) and/or chloride (Cl). The analytical device can also be equipped to determine several components by placing several measurement chambers one after the other.

The injection port 5 according to the invention is shown in detail in FIG. 3. The injection port 5 has a first feed opening 51 for receiving the sample and a discharge opening 52 that opens into the tubing 7 (see FIG. 2). The first feed opening 51 and the discharge opening 52 are connected to one another by an internal connecting channel 55, through which the sample flows.

Furthermore, the injection port 5 according to the invention has a second feed opening 53 for feeding a gas. The feed opening 53 adjoins a feed channel 56 that opens into the connecting channel 55. During operation oxygen or another gas is supplied to the connecting channel 55 of the injection port 5 via the second feed opening 53. This oxygen therefore passes into the water sample stream.

The first feed opening 51 of the injection port 5 can be closed off essentially gas-tight by a closing member, such as a septum 57, through which the injection needle 3 can be inserted. Furthermore, the first feed opening 51 of the injection port 5 has a conical guide surface 58. The guide surface 58 guides the injection needle during the insertion thereof into the injection port 5.

Of course, the connection of the second feed opening 53 and the connection of the discharge opening 52 are likewise essentially gas-tight.

The oxygen which is already added at the injection port 5 has a beneficial effect on the accuracy of the determination. The oxygen acts as a cooling agent for the sample. The chemical reactions of the sample will be postponed until the combustion chamber, which contains the catalyst. In addition, both oxidation and reduction can take place under favourable conditions. Moreover, the oxygen will carry along any solid impurities in the sample, so that the injection port or the introduction needle are less likely to become blocked.

The introduction module 12, that is arranged against the inlet side 11 of the combustion chamber 16, is shown on an enlarged scale in FIG. 4. The introduction module 12 has a central channel 40 into which the introduction needle 9 can be inserted. A cooling channel 41, which is supplied with oxygen via the feed opening 15 in the peripheral wall of the introduction module 12, is arranged concentrically with respect to the central channel 40. The cooling channel 41 has two channel sections 42, 43 that guide the oxygen in a zig-zag path along the wall 45 of the central channel 40. The oxygen then flows along the combustion chamber 16. The oxygen in the cooling channel 40 makes a contribution to cooling of the introduction needle 9.

1. Analytical device for analysing a sample, such as a water sample, comprising:
a combustion chamber for at least partially combusting the sample to give combustion products, wherein the combustion chamber has an inlet side and an outlet side;
a measurement chamber that is connected to the outlet side of the combustion chamber, wherein the measurement chamber has measuring means for measuring a component of the combustion products;
an introduction module that is arranged in fluid communication with the inlet side of the combustion chamber; as well as
an injection port that is arranged in fluid communication with the introduction module, which injection port has a first feed opening for receiving the sample and has a discharge opening that is in fluid communication with the first feed opening and is connected to the introduction module, wherein a second feed opening for feeding a gas is provided upstream of the introduction module.

2. The analytical device according to claim 1, wherein the second feed opening is made in the injection port.

3. The analytical device according to claim 1 or 2, wherein a source of oxygen is provided that is connected to the second feed opening for feeding oxygen.

4. The analytical device according to claim 1, wherein the second feed opening opens into the sample stream.

5. The analytical device according to claim 1, wherein the first feed opening of the injection port can be closed off essentially gas-tight by a closing member, such as a septum.

6. The analytical device according to claim 1, wherein the first feed opening of the injection port has a conical guide surface.

7. The analytical device according to claim 1, wherein the discharge opening of the injection port is connected to an introduction needle that can be accommodated in the introduction module.

8. The analytical device according to according to claim 7, wherein the introduction module has an elongated peripheral wall, which has a central channel for accommodating the introduction needle, which channel opens into the combustion chamber.

9. The analytical device according to according to claim 8, wherein the introduction module has a first gas inlet opening, for example for an inert gas, such as argon, to form a base flow to provide reference conditions in the measurement chamber.

10. The analytical device according to according to claim 8 or 9, wherein the introduction module has a second gas inlet opening, for example for oxygen, which connects to a cooling channel that is arranged adjacent to the central channel.

11. The analytical device according to according to claim 10, wherein the cooling channel has two channel sections which are connected in series, wherein the first channel section extends from the second gas inlet opening to a return point close to the combustion chamber and the second channel section extends from said return point back towards the gas inlet opening.

12. The analytical device according to claim 1, wherein the fluid communication between the injection port and the introduction needle is provided by a flexible tube.

13. The analytical device according to claim 1, wherein the inside of the introduction module is coated with a nickel foil.

14. The analytical device according to claim 1, wherein the introduction module comprises glass, preferably quartz glass.

15. The analytical device according to claim 1, wherein the injection port comprises Teflon.

16. Injection assembly intended for the analytical device according to claim 1, comprising an introduction module and an injection port that are connected to one another by a fluid communication, wherein the injection port has a first feed opening for receiving the sample and has a discharge opening that is in fluid communication with the first feed opening and is connected to the introduction module, wherein the injection port or the fluid communication between the introduction module and the injection port has a second feed opening for feeding a gas.

17. Method for analysing a sample, such as a water sample, comprising feeding the sample to an injection port, transporting the sample from the injection port to an introduction module, which can be connected to a combustion chamber, transferring the sample from the introduction module to the combustion chamber, at least partially combusting the sample to give combustion products in the combustion chamber, transporting the combustion products from the combustion chamber to a measurement chamber, measuring a component of the combustion products in the measurement chamber, wherein a gas is fed to the sample upstream of the introduction module.

18. The method according to claim 17, wherein the gas is fed to the injection port.

19. The method according to claim 17 or 18, wherein the gas comprises oxygen.

20. The method according to claim 17, wherein the gas comprises an inert gas, such as argon.

21. The method according to claim 17, wherein the sample is fed to the injection port by means of an injection needle.

22. The method according to claim 17, wherein a gas stream is fed to the introduction module, and wherein the stream of the sample is separated from said gas stream by a dividing wall in the introduction module, and wherein heat transfer from the sample to the gas stream takes place.
